(19) United States
(12) Patent Application Publication
(10) Pub. No.: US 2009/0279199 A1
(43) Pub. Date: Nov. 12, 2009

(54) Method and apparatus for reducing slider contact probability in a load-unload (LUL) hard disk drive

(75) Inventor: Shuyn Zhang, Fremont, CA (US)

Correspondence Address: GREGORY SMITH & ASSOCIATES, 3900 NEWPARK MALL ROAD, 3RD FLOOR, NEWARK, CA, 94560, US

(73) Assignee: Samsung Electronics Co., LTD.

(21) Appl. No.: 12/152,306

(22) Filed: May 12, 2008

(51) Int. Cl. G11B 21/02

(52) U.S. Cl. 360/75

(57) ABSTRACT

A Load-UnLoad hard disk drive (HDD) with a roll static angle between the slider and the rotating disk surface of at most zero degrees is disclosed. Put another way, the slider contact with the disk surface during loading is reduced when the outer edge is not nearer than the inner edge of the slider to the disk surface. A head gimbal assembly holding a slider so that the slider will have a roll static angle of at most zero degrees in the HDD. A head stack assembly including at least one of these head gimbal assemblies. Operating a HDD where the slider is loaded onto the rotating disk surface at a roll static angle that is at most zero degrees.

### TECHNICAL FIELD

This invention relates to sliders and their air bearing surfaces in Load-UnLoad (LUL) hard disk drives.

### BACKGROUND OF THE INVENTION

In a Load-UnLoad (LUL) hard disk drive, each slider with its read and write heads is loaded onto a rotating disk surface to access the data stored on the disk surface, and unloaded from the rotating disk surface when-the slider is no longer needed. The process of loading the slider onto the rotating disk surface establishes an air bearing between the air bearing surface of the slider and a wind off the rotating disk surface to create a stable flying state of the slider. Sometimes the air bearing gets disrupted and the slider makes contact with the disk surface during this loading process, potentially damaging the disk surface and/or the slider, as well as generating particulate debris that may adversely affect other components of the hard disk drive. While the problem has been reduced by several approaches, it continues to undermine the reliability of LUL hard disk drives.

### SUMMARY OF THE INVENTION

Embodiments of the invention include a Load-UnLoad (LUL) hard disk drive with a roll static angle between the slider and the rotating disk surface of at most zero degrees. Put another way, the slider contact with the disk surface during loading is reduced when the outer edge is not nearer than the inner edge of the slider to the disk surface. Preferably, the roll static angle is at least negative one degree. Further preferred, the roll static angle is at least −0.6 degrees.

Embodiments of the invention further include head suspension assemblies to hold the slider so that a head gimbal assembly formed of these components will have a roll static angle of at most zero degrees in the LUL hard disk drive. The embodiments further include a head stack assembly including at least one of these head gimbal assemblies.

Embodiments of the invention include operating a LUL hard disk drive where the slider is loaded onto the rotating disk surface at a roll static angle that is at most zero degrees. This minimizes occurrences of slider contact with the disk surface during the loading process without requiring major changes to the suspension or air bearing surface.

### BRIEF DESCRIPTION OF THE DRAWINGS

FIG. 1 shows a cutaway top view of an example of an embodiment of the invention as a hard disk drive including a voice coil motor pivoting on a disk base to position via a head gimbal assembly, a slider over a rotating disk surface that induces a wind.

FIG. 2A shows a perspective view of some details of the voice coil motor of FIG. 1, including a head stack assembly interacting through its voice coil with a fixed magnet assembly. The head stack assembly also includes at least one head gimbal assembly and pivots about an actuator pivot.

FIG. 2B shows a side view of the head gimbal assembly, its slider, and the rotating disk surface. The slider includes a trailing edge intersecting with an air bearing surface that interacts with the wind off the rotating disk surface to create an air bearing by which the slider flies over the disk surface.

FIGS. 2C and 2D show schematically the relationship between the wind, the slider sides, a positive roll angle and the pitch angle as seen from the disk surface.

### DETAILED DESCRIPTION

This invention relates to sliders and their air bearings in Load-UnLoad (LUL) hard disk drives. Embodiments of the invention include a LUL hard disk drive with a roll static angle between the slider and the rotating disk surface of at most zero degrees. Put another way, the slider contact with the disk surface during loading is reduced when the outer edge is not nearer than the inner edge of the slider to the disk surface.

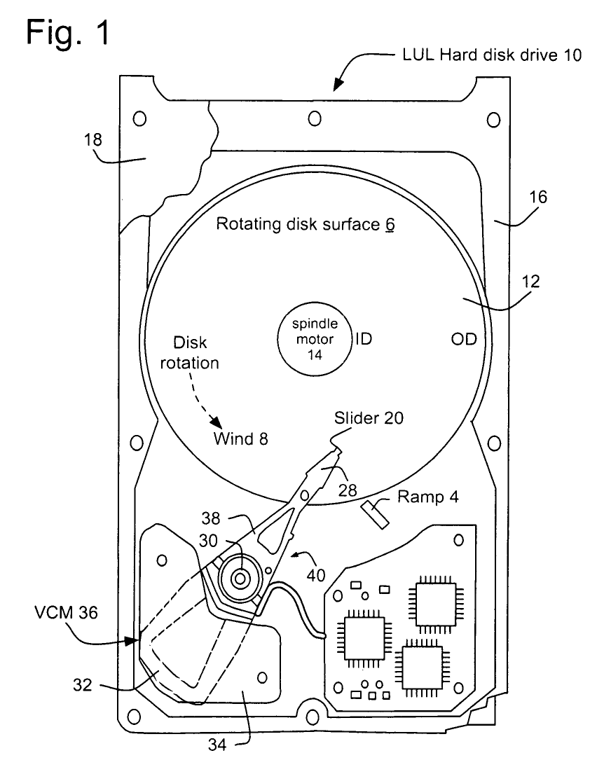

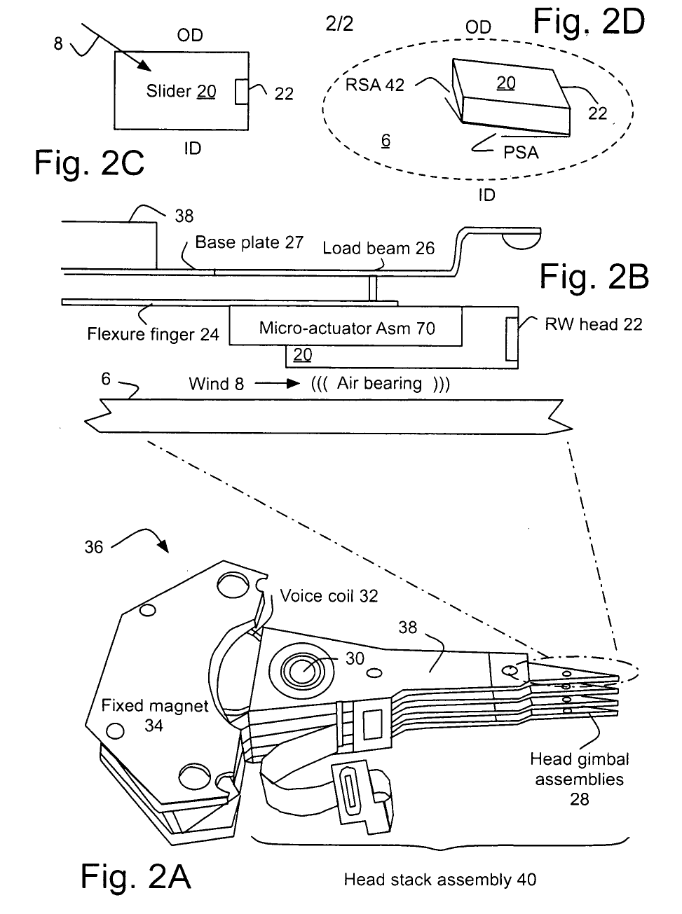

Referring to the drawings more particularly by reference numbers, FIG. 1 shows a cutaway top view of an example embodiment of the invention as a LUL hard disk drive 10 including a disk base 16 and the following components: A spindle motor 14 mounted on the disk base and rotatably coupled to at least one disk 12 to create a rotating disk surface 6. A voice coil motor 36 including a head stack assembly 40 is mounted to the disk base by an actuator pivot 30, about which it pivots, using an actuator arm 38 to position a head gimbal assembly 28 and its slider 20 over the rotating disk surface to access data stored on that surface. The head stack assembly also includes a voice coil 32. The voice coil is stimulated by a time-varying electrical signal and magnetically interacts with a fixed magnet assembly 34 to move the head gimbal assembly by lever action through the actuator pivot. The rotating disk surface induces a wind 8 that interacts with the slider as will be discussed with regards FIG. 2B to 2D.

When an LUL hard disk drive 10 is not accessing the rotating disk surfaces 6, the voice coil motor 36 frequently moves the sliders 20 to a parking condition using a ramp 4, which may be located near the Outside Diameter (OD) as shown or Inside Diameter (ID) by the spindle motor 14. This invention applies to LUL hard disk drives whether their ramp is near the outside diameter or near the spindle motor. This disk drive operation of moving the sliders to the parking condition will be referred to as unloading.

When the LUL hard disk drive 10 has the sliders 26 parked on the ramp 4, a loading operation is performed to prepare the sliders to access the rotating disk surfaces 6. First the spindle motor is stimulated to rotate the disks 12 as a loading speed. Then the voice coil is stimulated, causing the voice coil motor to release the sliders from the ramp. Each slider is brought close to the rotating disk surface, where the wind off the disk surface interacts with the air bearing surface to form the air bearing as shown in FIG. 2B.

FIG. 2A shows a perspective view of some details of the voice coil motor 36 of FIG. 1, including the head stack assembly 40 interacting through the voice coil 32 with the fixed magnet assembly 34. The head stack assembly also includes at least one head gimbal assembly 28 and pivots about the actuator pivot 30. Note that this head stack assembly includes more than two actuator arms 38, each of which is mechanically coupled to one or two of the head gimbal assemblies and supporting LUL hard disk drives including more than one disk.

FIG. 2B shows a side view of the head gimbal assembly 28, its slider 20, and the rotating disk surface 6. The slider includes a read-write head 22 and an air bearing surface that faces the disk surface. The air bearing surface interacts with the wind 8 off the rotating disk surface to create an air bearing for the slider to fly over the disk surface.

The head gimbal assembly 28 may preferably include a micro-actuator assembly 70 coupling to the slider 20 and preferably a flexure finger 24. The micro-actuator assembly is frequently used to provide a second stage of actuation in the positioning of the read-write head over the rotating disk surface. The head gimbal assembly may include a base plate 27 coupling to the actuator arm. The base plate may couple to the load beam 26 coupling to the base plate often through a spring. The flexure finger with the coupled micro-actuator assembly and slider mechanically couple to the load beam. The lead beam may also include a guide for contacting the ramp as shown in the upper right hand corner of this Figure.

FIG. 2C shows the interaction of the wind 8 off of the rotating disk surface 6 with regards to the outside diameter OD and the Inside Diameter ID of the disk 12 as shown in FIG. 1 and the read-write head 22 of FIG. 2B.

FIG. 2D shows the Pitch Static Angle PSA and the roll static angle 42 of the slider 20 with respect to the rotating disk surface 6 of FIG. 2B. This Figure shows the roll static angle with a positive angle, and the inside edge of the slider is nearer the disk surface than the outside edge. Various embodiments of the invention include the outside edge at least as close to the disk surface as the outside edge.

| | 0 | 0.2 | 0.4 | 0.6 | 0.8 | 1 | 1.2 | 1.4 | 1.6 | 1.8 | 2 | 2.2 | 2.4 | 2.6 |
|---|---|---|---|---|---|---|---|---|---|---|---|---|---|---|
| −1 | 0.021 | 0.022 | 0.022 | 0.021 | 0.021 | 0.022 | 0.021 | 0.021 | 0.022 | 0.021 | 0.021 | 0.022 | 0.023 | 0.022 |
| −0.8 | 0.021 | 0.022 | 0.021 | 0.022 | 0.021 | 0.022 | 0.021 | 0.021 | 0.021 | 0.021 | 0.021 | 0.021 | 0.022 | 0.022 |
| −0.6 | 0.021 | 0.022 | 0.022 | 0.022 | 0.022 | 0.022 | 0.022 | 0.021 | 0.022 | 0.022 | 0.021 | 0.021 | 0.023 | 0.022 |
| −0.4 | 0.022 | 0.022 | 0.022 | 0.022 | 0.022 | 0.022 | 0.022 | 0.022 | 0.022 | 0.022 | 0.022 | 0.022 | 0.023 | 0.021 |
| −0.2 | 0.022 | 0.022 | 0.022 | 0.023 | 0.022 | 0.022 | 0.022 | 0.022 | 0.022 | 0.022 | 0.022 | 0.021 | 0.023 | 0.022 |
| 0 | 0.022 | 0.022 | 0.022 | 0.023 | 0.022 | 0.022 | 0.023 | 0.022 | 0.022 | 0.022 | 0.022 | 0.022 | 0.022 | 0.022 |
| 0.2 | 0.022 | 0.022 | 0.022 | 0.022 | 0.022 | 0.022 | 0.022 | 0.022 | 0.022 | 0.023 | 0.024 | 0.056 | 0.057 | 0.443 |
| 0.4 | 0.022 | 0.022 | 0.022 | 0.023 | 0.023 | 0.022 | 0.022 | 0.224 | 0.288 | 0.325 | 0.401 | 0.439 | 0.471 | 0.521 |
| 0.6 | 0.022 | 0.022 | 0.022 | 0.023 | 0.023 | 0.022 | 0.086 | 0.214 | 0.346 | 0.355 | 0.443 | 0.501 | 0.61 | 0.634 |
| 0.8 | 0.021 | 0.022 | 0.023 | 0.024 | 0.023 | 0.057 | 0.161 | 0.249 | 0.374 | 0.43 | 0.512 | 0.52 | 0.452 | 0.285 |
| 1 | 0.022 | 0.023 | 0.022 | 0.023 | 0.022 | 0.105 | 0.2 | 0.287 | 0.328 | 0.248 | 0.262 | 0.32 | 0.367 | 0.261 |

Table One: simulation results of the contact noise for various combinations of pitch static angles shown in the column headings in the top row and roll static angles shown in the row headings on the right during slider loading. The pitch static angle and the roll static angles are reported in degrees of arc. The contact noise is a function of the stable flying height. The contact noise is minimized when the roll static angle is at most zero degrees for a range of pitch static angles showing reduced incidence of contact during loading of the slider 20, and stays close to minimum for roll static angles of at least negative one degree. It may be preferred to manufacture the hard disk drive 10 with a roll static angle between zero degrees and negative one degree. It may be further preferred for the hard disk drive to have a roll static angle between a sub-range, for example negative two tenths degree and negative eight tenths degree, or further, between negative four tenths degree and negative six tenths degree. The range of zero to negative one degree may be preferred for the lifetime of the hard disk drive, however its manufacture may prefer one of these sub-ranges, due the overall effects of aging upon the hard disk drive.

Several things should be noted: The micro-actuator assembly 70 may use any one or more of the following physical effects: a piezoelectric effect, a thermal-mechanical effect and an electro-static effect to alter the position of the slider 20 over the rotating disk surface 6. The micro-actuator assembly may affect the roll and/or pitch of the slider, and may be employed during loading processes to create the roll static angle 42 as claimed in this patent application. The slider may include a vertical micro-actuator to alter the flying height during disk access and/or loading.

The preceding embodiments provide examples of the invention, and are not meant to constrain the scope of the following claims.

What is claimed is:

1. A Load-UnLoad hard disk drive, comprising:
a disk base;
a spindle motor mounted on said disk base and rotatably coupled to at least one disk to create a rotating disk surface, said rotating disk surface inducing a wind;
a voice coil motor including a head stack assembly for pivoting about an actuator pivot to said disk base to unload a slider with an air bearing surface at roll static angle above said rotating disk surface and interacting with said wind to fly said slider at a flying height above said rotating disk surface, whereby said roll static angle is at most zero degrees.

2. The Load-UnLoad hard disk drive of claim 1, wherein said roll static angle is at least negative one degree.

3. The Load-UnLoad hard disk drive of claim 2, wherein said roll static angle is between negative two tenths degree and negative eight tenths degree.

4. A head gimbal assembly for a Load-UnLoad hard disk drive, comprising:
a head suspension assembly coupled to a slider to unload said slider onto a rotating disk surface in said LUL hard disk drive at a roll static angle of at most zero degrees.

5. The head gimbal assembly of claim 4, wherein said roll static angle is at least negative one degree.

6. The head gimbal assembly of claim 5, wherein said roll static angle is between negative two tenths degree and negative eight tenths degree.

7. A head stack assembly for a Load-UnLoad hard disk drive, comprising at least one head gimbal assembly configured to unload a slider onto a rotating disk surface of said LUL hard disk drive at a roll static angle of at most zero degrees.

8. A method, comprising the step of:
loading a slider of a Load-UnLoad hard disk drive onto a rotating disk surface at a roll static angle of at most zero degrees.

9. The method of claim 8, wherein said roll static angle is at least negative one of said degree.

10. The method of claim 9, wherein said roll static angle is between negative two tenths degree and negative eight tenths degree.
